(19) United States
(12) Patent Application Publication
(10) Pub. No.: US 2009/0073143 A1
(43) Pub. Date: Mar. 19, 2009

(54) Content management system

(75) Inventors: Toshiroh Shimada, Kanagawa (JP); Tsutomu Ishii, Kanagawa (JP); Akira Ichiboshi, Kanagawa (JP); Hajime Ueno, Kanagawa (JP); Yoko Kurihara, Kanagawa (JP); Minoru Koshimizu, Kanagawa (JP); Yasunori Saito, Kanagawa (JP); Shigehiko Sasaki, Kanagawa (JP); Masahiro Sato, Kanagawa (JP); Tomoyuki Shoya, Kanagawa (JP); Kyotaro Tomoda, Kanagawa (JP); Naoki Hayashi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/081,469

(22) Filed: Apr. 16, 2008

(30) Foreign Application Priority Data
Sep. 18, 2007 (JP) 2007-241439

(51) Int. Cl. G06F 3/033

(52) U.S. Cl. 345/179

(57) ABSTRACT

A contents management system includes a writing device and a management device. The writing device includes a writing section, an image retaining section, a judging section and a control section. The writing device writes a content image onto electronic paper which displays and retains an image in a no-power state and is configured to rewrite the image. And the management device includes a management section, control section and an update section. The management device manages content to be written onto and displayed on the electronic paper.

### CROSS-REFERENCE TO RELATED APPLICATIONS

This application is based on and claims priority under 35 USC 119 from Japanese Patent Application No. 2007-241439 filed Sep. 18, 2007.

### BACKGROUND

1. Technical Field

The present invention relates a system which manages content written onto electronic paper, and particularly to a technique for preventing a content image from remaining displayed on the electronic paper out of management.

2. Background Art

In order to manage contents of documents utilized in an office, browsing, editing, and printing operations of the contents are recorded as history. In case that the contents leak out by mistake, speedy measures can be taken by specifying a leakage path of the contents on the basis of the history.

In recent years, electronic paper which displays and retains a content image in a no-power state and which is rewritten the document image has been utilized, and the spread of the use of the electronic paper has been desired as a contents display medium which is substituted for the paper sheet.

The electronic paper is divided in the form of writing the content image onto various types, for example, optical write type electronic paper and electronic write type electronic paper. The optical write type electronic paper displays and retains a content image by projecting the content image by a writing device, and the electronic write type electronic paper displays and retains a content image by writing the content image based on electronic data by a writing device.

In any type of electronic paper, the displayed document may carry the image readily. Therefore, the electronic paper is useful as a medium for displaying contents in a mobile environment.

In case of browsing the contents by use of the electronic paper, there are advantages that a content image may be displayed on and retained in the electronic paper in a no-power state and may be freely carried, and that the electronic paper may be rewritten the displayed contents to another contents and may be used repeatedly. The contents management utilizing such the electronic paper is performed by managing identification information of electronic paper and identification information of content written in the electronic paper.

### SUMMARY

According to an aspect of the invention, a contents management system includes a writing device that writes a content image onto electronic paper which displays and retains an image in a no-power state and is configured to rewrite the image, and a management device that manages content to be written onto and displayed on the electronic paper. The management device includes a management section, control section and an update section. The management section manages identification information of electronic paper associated with identification information of content written onto and displayed on the electronic paper. The control section, in accordance with reception of a request from the writing device, transmits content to the writing device, the request which includes identification information of electronic paper to be written. The update section stores, in the management section, the identification information of the content to be transmitted to the writing device, in accordance with the reception of the request from the writing device, associated with the identification information of the electronic paper. The writing device includes a writing section, an image retaining section, a judging section and a control section. The writing section writes an image onto electronic paper. The image retaining section stores an image for erasure. The judging section reads an image displayed on and retained in electronic paper for writing and judges conformity of the image read by the judging section with the image for erasure. The control section transmits, in accordance with a judgment result indicating the conformity with the image for erasure, the request including the electronic paper identification information to the management device.

### BRIEF DESCRIPTION OF THE DRAWINGS

Exemplary embodiment(s) of the present invention will be described in detail based on the following figures, wherein

FIG. 1 is a diagram showing a contents management system according to one exemplary embodiment of the invention;

FIG. 2 is a diagram for explaining processing of the contents management system according to one exemplary embodiment of the invention;

FIG. 3 is a diagram for explaining processing of the contents management system according to one exemplary embodiment of the invention;

FIG. 4 is a diagram for explaining processing of the contents management system according to one exemplary embodiment of the invention;

FIG. 5 is a diagram for explaining processing of the contents management system according to one exemplary embodiment of the invention;

FIG. 6 is a diagram for explaining processing of the contents management system according to one exemplary embodiment of the invention; and

FIG. 7 is a diagram for explaining processing of the contents management system according to one exemplary embodiment of the invention.

### DETAILED DESCRIPTION

A contents management system according to one exemplary embodiment of the invention will be described.

First, electronic paper which is utilized in the contents management system in this example will be described.

The electronic paper is divided in the form of writing an image onto various types. Herein, electronic write type electronic paper onto which an image is electronically written by a writing device, and optical write type electronic paper onto which an image is written by projection by a writing device will be described.

The electronic write type electronic paper is a flexible and thin medium having size such as A4-sized paper, and has a structure in which very fine colored particles (for example, white-colored particles and black-colored particles) utilized as toners in a copying machine are enclosed in between a pair of front and rear electrodes of which at least the front side is transparent, and the resulting laminated body is sandwiched in between a pair of front and rear film substrates of which at least the front side is transparent. Herein, an air layer is formed between the electrodes so that the colored particles can freely move. Further, the electrode layers arranged in the shape of a matrix are provided with insulating layers for preventing contact with the colored particles. Further, by using a color filter, color display can be realized in a simple structure.

The electronic write type electronic paper operates in such a manner that; in a state where no voltage is applied to the electrodes, the white particles charged in minus gather on the rear side, whereas the black particles charged in plus gather on the front side, so that the electronic write type electrode paper falls into a black state when seen visually from the front side. Further, when a writing section (driver) of the writing device operates based on electronic data so as to invert the electrode polarities of the required parts of the matrix which correspond to an image to be displayed, the positional relation between the white particles and the black particles are replaced, and an image which is based on the contrast between the white particles and the black particles is displayed. Further, by operating the driver of the writing device on the basis of the different electronic data, the image displayed on the basis of the contrast between the white particles and the black particles may be changed over, and the electronic write type electronic paper may be reused many times.

The optical write type electronic paper is a flexible and thin medium having size such as A4-sized paper. For example, in such a way that an image to be written is displayed on a writing section (liquid crystal panel) of a writing device, and that the optical write type electronic paper is irradiated with light in superposition on the liquid crystal panel with a voltage applied to write electrodes of the electronic paper from an external power source, the image displayed on the liquid crystal panel may be transferred to the electronic paper and the electronic paper may display and store the image displayed on the liquid crystal panel. Even after the voltage applied to the write electrodes has been removed, the optical write type electronic paper continues to retain the image with displaying the image.

The optical write type electronic paper has a structure in which a layer of organic photoconductive material (organic photoconductive layer) utilized in a copying machine is combined with a layer of liquid-crystal display material (cholesteric liquid crystal layer put in the form of microcapsules), these layers are sandwiched in between a pair of front and rear transparent electrodes, and the resulting laminated body is sandwiched in between a pair of front and rear transparent substrate films. This configuration enables the monochromatic image display of a white display which is based on the reflection of light by the cholesteric liquid crystal layer, and a black display which is based on the transmission of light through the liquid crystal layer and the subsequent absorption of the light by a black layer that is interposed between the cholesteric liquid crystal layer and the organic photoconductive layer. Further, a cholesteric liquid crystal has the property that color light corresponding to a spiral pitch is reflected by interference. Therefore, a color display can be realized by a simple structure in such a way that the cholesteric liquid crystal layer is configured by stacking liquid crystals of different spiral pitches.

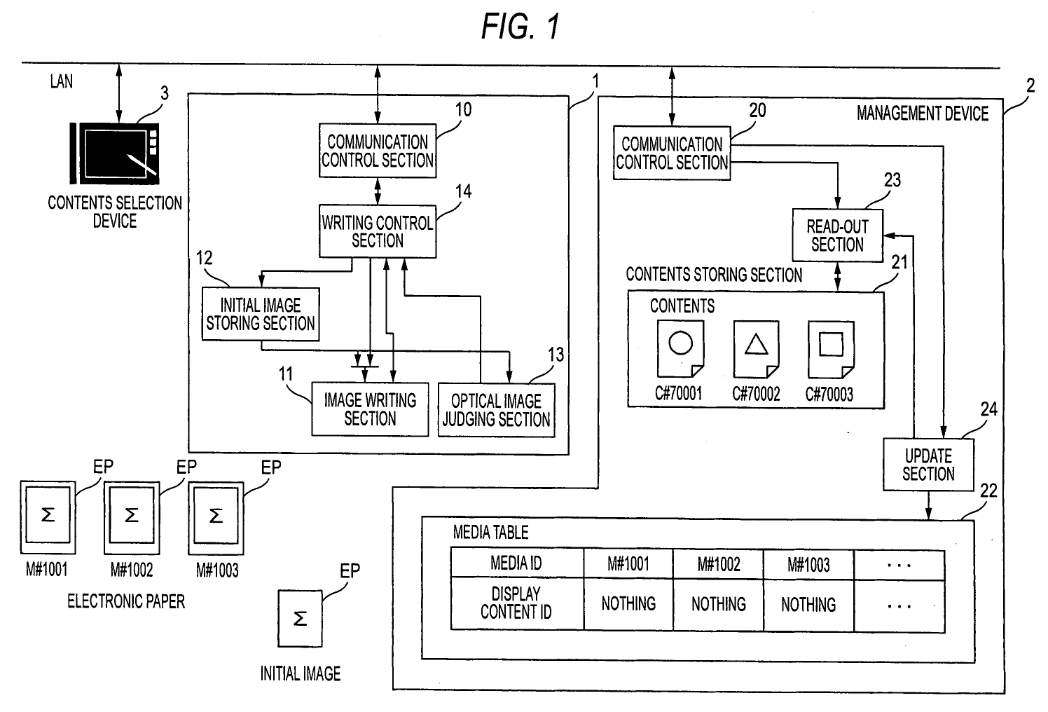

FIG. 1 shows a contents management system according to this example.

The contents management system in this example has the configuration in which a writing device 1 and a management device 2 and a selection device 3 are connected through a network (LAN). The writing device 1 writes an image onto electronic paper EP which is configured to display and retain an image in a no-power state and which is configured to be rewritten the image. The management device 2 manages contents to be written onto and displayed on the electronic paper EP, and a selection device 3 transmits an instruction for rewriting the content image to the writing device 1 upon reception of operational input from a user.

In this example, as the selection device 3 which receives the operational input from the user, a communication terminal (a mobile telephone, a mobile PC, or the like) which connects to the network through a wireless line is used. However, the system may have the configuration in which the function of receiving the operational input from the user is provided in the writing device 1, but the selection device 3 is not provided.

The writing device 1 includes a communication control section 10, an image writing section 11, an initial image storing section 12, an optical image judging section 13 and a writing control section 14. The communication control section 10 performs communication processing through the network. The image writing section 11 writes an image onto the electronic paper EP. The initial image storing section 12 retains an initial image as an image for erasure. The optical image judging section 13 reads identification information (MEDIA ID) recorded in the electronic paper EP for writing, and reads optically the image displayed on and retained in the electronic paper EP to judge conformity between the displayed and retained image and the initial image. And the writing control section 14 transmits, in accordance with a judgment result indicating the conformity with the initial image, a request including the electronic paper identification information (MEDIA ID) and content identification information (DISPLAY CONTENT ID) for specifying content to be written which have been input from the selection device 3 by the user, to the management device 2 through the communication control section 10.

In this example, the electronic paper identification information (MEDIA ID) is coded and printed in each electronic paper EP, and the optical image judging section 13 reads optically and acquires the electronic paper identification information. However, by installing a memory in the electronic paper and storing the electronic paper identification information in the memory as electronic data, the optical image judging section 13 may read electrically and acquires the electronic paper identification information.

The above each function of the writing device 1 in this example is configured by executing a program according to the invention by means of a computer.

The management device 2 includes a communication control section 20, a contents storing section 21 a management table 22, a read-out section 23 and an update section 24. The communication control section 20 performs communication processing through the network. The contents storing section 21 stores plural contents to be supplied to the writing device 1. The management table 22 stores and manages the identification information (MEDIA ID) of the electronic paper EP and the identification information (DISPLAY CONTENT ID) of the contents written onto and displayed on the electronic paper in association. The read-out section 23, in accordance with reception of the request including the electronic paper identification information for writing and the content identification information from the writing device 1, reads out the content specified by the request from the contents storing section 21. And the read-out section 23 transmits, through the communication control section 20, the specified contents to the writing device 1 that has transmitted the request. And the update section 24 stores, in the management table 22, the content identification information (DISPLAY CONTENT ID) to be transmitted to the writing device 1, in accordance with the reception of the request from the writing device 1 in association with the requested electronic paper identification information (MEDIA ID).

In this example, the read-out section 23 converts the read-out content into a type (content image) writable onto the electronic paper EP, and thereafter transmits the content image to the writing device 1 through the communication control section 20. However, the before-conversion content may be transmitted to the writing device 1 from the management device 2 and may be converted on the writing device 1 side.

Further, in the example, though the contents storing section 21 is provided integrally with the management device 2, the contents storing section 21 may be provide as a server on the network, and the management device 2 may access to the server to acquire the required contents.

The above each function of the management device 2 in this example is configured by executing a program according to the invention by means of a computer.

Next, processing by the thus configured contents management system will be described.

First, in a state shown in FIG. 1, in none of three sheets of electronic paper EP having respectively identification information (MEDIA ID) M#1001, M#1002, and M#1003, content images are written and displayed (initial images are written onto and displayed on the three sheets of electronic paper EP).

Under this state, in the management table 22 of the management device 2, information (Nothing) indicating that contents have not been written are recorded in association with the identification information of each electronic paper EP under management.

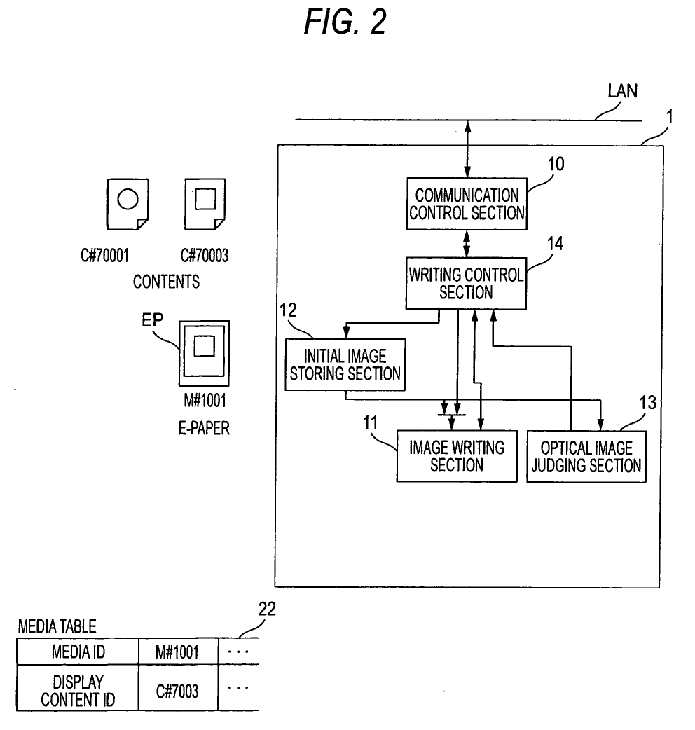

As shown in FIG. 2, in a state where an image of content of which content identification information (DISPLAY CONTENT ID) is C#7003 is written onto and displayed on the electronic paper EP of which the identification information (MEDIA ID) is M#1001, in the management table 22 of the management device 2, the content identification information (DISPLAY CONTENT ID) C#7003 is recorded and managed in association with the electronic paper identification information (MEDIA ID) M#1001.

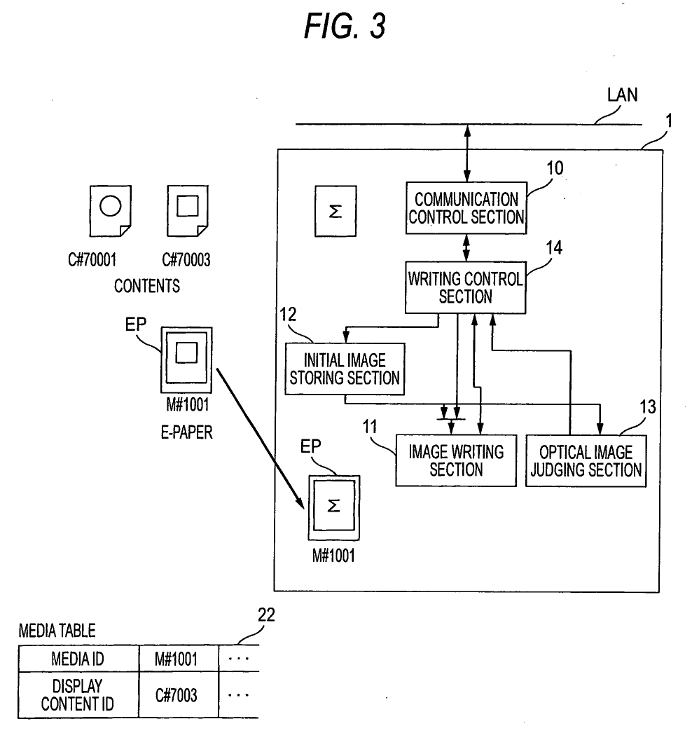

From the state shown in FIG. 2, when the user operates the selection device 3 to give an instruction for rewriting the display contents (C#7003) of the electronic paper EP (M#1001) to another contents (C#7001) to the writing device 1, and sets the electronic paper EP (M#1001) in the writing device 1 as shown in FIG. 3, the writing device 1 writes and displays, onto and on the set electronic paper EP (M#1001), the initial image stored in the initial image storing section 12, by means of the image writing section 11.

In this state, in the management table 22 of the management device 2, the display contents of the electronic paper EP (M#1001) remains C#7003.

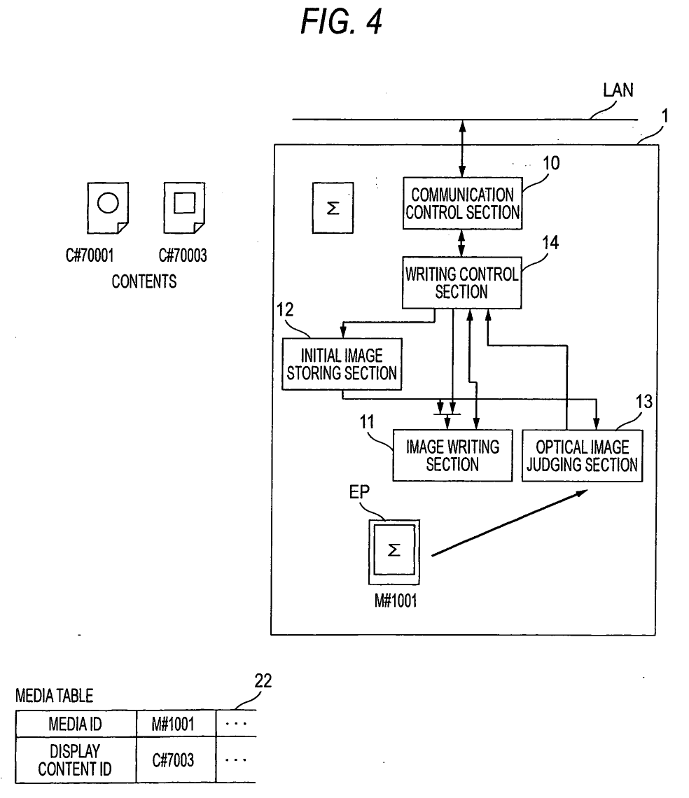

Next, as shown in FIG. 4, the optical image judging section 13 reads an image of the electronic paper EP (M#1001) onto and on which the initial image has been written and displayed, and judges whether or not the initial image stored in the initial image storing section 12 coincides with the image read from the electronic paper. Namely, the optical image judging section 13 judges whether or not the initial image is properly written onto the electronic paper EP and the original content image (C#7003) is rewritten to the initial image and erased.

In this image reading judgment, since the initial image is a simply graphic image, the image resolution of the optical image judging section 13 does not need to be so high to obtain enough accuracy in judgment. This point is similar also in the case in which the initial image (image for erasure) is a blank image.

In the same figure, as a matter of convenience, an image writing position by the image write section 11 and an image reading position by the optical image judging section 13 are shown so as to be different from each other. However, these positions may be the same or different, and determined by setting of the image write section 11 and the optical image judging section 13 in the writing device 1.

As a result of the above judgment, in case that the conformity with the initial image is not obtained, the writing device 1 gives error notice to the user and stops the processing.

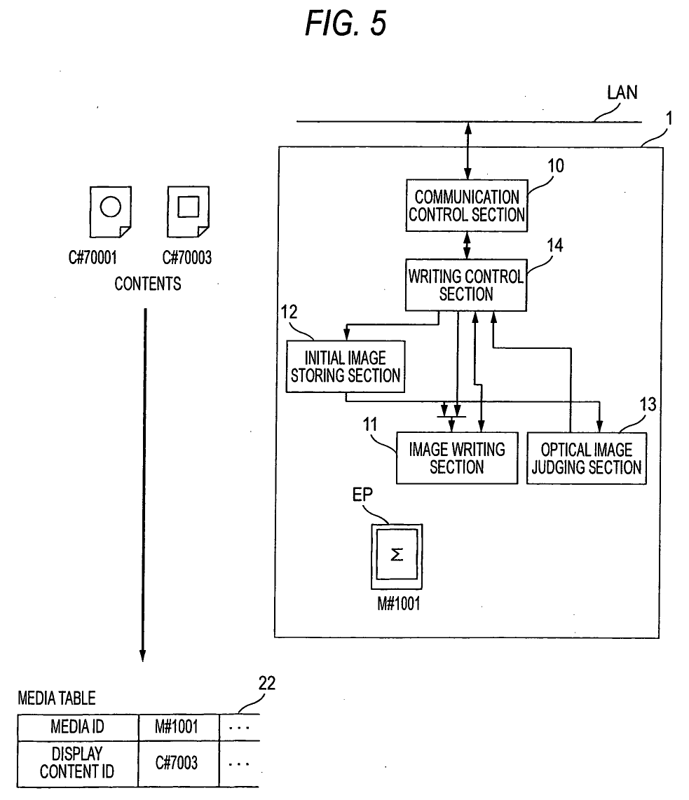

On the other hand, as a result of the above judgment, in case that the conformity with the initial image is obtained, the writing control section 14 of the writing device 1 transmits a request including identification information (C#7001) of contents for rewriting on which the user has given the instruction, the electronic paper identification information (M#1001) obtained in the reading processing by the optical image judging section 13, and also self address information of a sender, through the communication control section 10 to the management device 2, and waits for rewrite of the content as shown in FIG. 5.

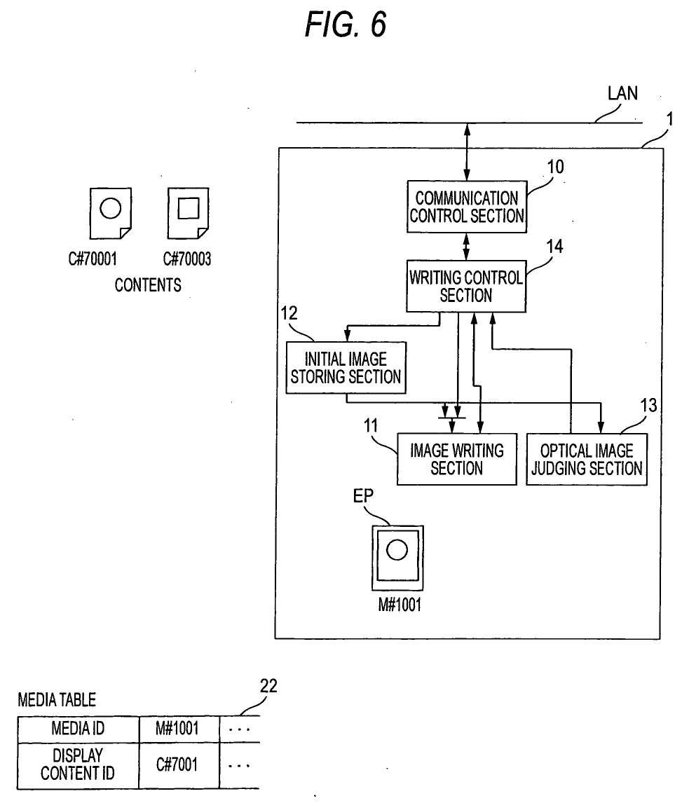

When the management device 2 receives the above request from the writing device 1, the read-out section 23 reads out the content of the requested content identification information (C#7001) from the contents storing section 21 and converts the read-out content into a type for electronic paper display, and transmits, through the communication control section 20, a content image obtained by the conversion to the writing device which has transmitted the request. Further, simultaneously, as shown in FIG. 6, in the management device 2, the update section 24 records the transmitted content identification information (C#7001) in the management table 22 in association with the requested electronic paper identification information (M#1001). Namely, in the management table 22, the content identification information in association with electronic paper identification information M#1001 is rewritten from C#7003 to C#7001.

The writing device 1, upon reception of the above content image from the management device 2, writes and displays an image of the contents (C#7001) onto and on the electronic paper identification information (M#1001) by section of the image writing section al and displays the image.

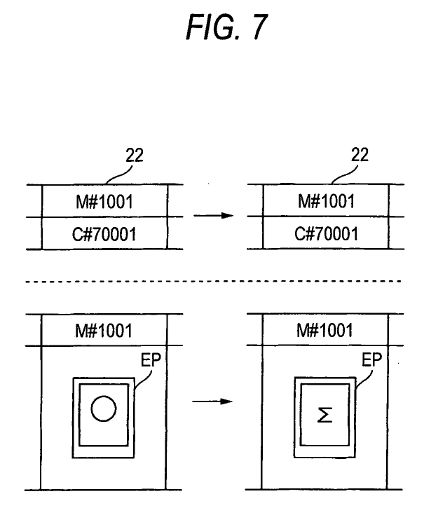

As described above, according to the contents management system in this example, as shown in FIG. 7, in case that a contents (C#7001) written onto and displayed on electronic paper (M#1001) is rewritten to another contents, an image for erasure (initial image) is intermediately written onto the electronic paper. Next, whether or not this image form erasure has been surely written and the original content image (C#7001) has been erased is judged and confirmed. In this judgment period, the management table maintains the original state (state where the contents (C#7001) is displayed in the electronic paper (M#1001)). Hereby, even if writing of the image for erasure is not performed enough (the conformity in the reading judgment is not obtained), and the original content image (C#7001) remains in the electronic paper (M#1001), consistency between the data in the management table 22 and the actual data is maintained.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A contents management system comprising:
a writing device that writes a content image onto electronic paper which displays and retains an image in a no-power state and is configured to rewrite the image; and
a management device that manages content to be written onto and displayed on the electronic paper,
wherein the management device includes:
a management section that manages identification information of electronic paper associated with identification information of content written onto and displayed on the electronic paper;
a control section that, in accordance with reception of a request from the writing device, transmits content to the writing device, the request which includes identification information of electronic paper to be written; and
an update section that stores, in the management section, the identification information of the content to be transmitted to the writing device, in accordance with the reception of the request from the writing device, associated with the identification information of the electronic paper, and
the writing device includes:
a writing section that writes an image onto electronic paper;
an image retaining section that stores an image for erasure;
a judging section that reads an image displayed on and retained in electronic paper for writing and judges conformity of the image read by the judging section with the image for erasure; and
a control section that transmits, in accordance with a judgment result indicating the conformity with the image for erasure, the request including the electronic paper identification information to the management device.

2. The contents management system according to claim 1, further comprising:
a selection device which transmits, upon reception of operational input from a user, an instruction for rewriting a content image onto the writing device.

3. The contents management system according to claim 1,
wherein the management device includes a contents memory device which stores a plurality of contents to be transmitted to the writing device.

4. The contents management system according to claim 1, wherein the image for erasure is a simple graphics image.

5. The contents management system according to claim 1,
wherein the image for erasure is an blank image.

6. A management device of a contents management system, the management device that manages content to be written onto and displayed on electronic paper comprising:
a management section that manages identification information of the electronic paper associated with identification information of content written onto and displayed on the electronic paper;
a control section that, in accordance with reception of a request from a writing device, transmits content to the writing device, the request which includes identification information of electronic paper to be written; and
an update section that stores, in the management section, the identification information of the content to be transmitted to the writing device, in accordance with the reception of the request from the writing device, associated with the identification information of the electronic paper.

7. The management device according to claim 6,
wherein the writing device writes a content image onto electronic paper which displays and retains an image in a no-power state and is configured to rewrite the image, and
the writing device includes:
a writing section that writes an image onto electronic paper;
an image retaining section that stores an image for erasure;
a judging section that reads an image displayed on and retained in electronic paper for writing and judges conformity of the image read by the judging section with the image for erasure; and
a control section that transmits, in accordance with a judgment result indicating the conformity with the image for erasure, the request including the electronic paper identification information to the management device.

8. A writing device of a contents management system, a writing device that writes a content image onto electronic paper which displays and retains an image in a no-power state and is configured to rewrite the image comprising:
a writing section that writes an image onto electronic paper;
an image retaining section that stores an image for erasure;
a judging section that reads an image displayed on and retained in electronic paper for writing and judges conformity of the image read by the judging section with the image for erasure; and
a control section that transmits, in accordance with a judgment result indicating the conformity with the image for erasure, the request including the electronic paper identification information to a management device.

9. The writing device according to claim 8, wherein the management device that manages content to be written onto and displayed on electronic paper, and
the management device includes:
a management section that manages identification information of the electronic paper associated with identification information of content written onto and displayed on the electronic paper;
a control section that, in accordance with reception of a request from the writing device, transmits content to the writing device, the request which includes identification information of electronic paper to be written; and
an update section that stores, in the management section, the identification information of the content to be transmitted to the writing device, in accordance with the reception of the request from the writing device, associated with the identification information of the electronic paper.

10. A computer readable medium storing a program causing a computer to execute a process for managing contents, the process comprising:
managing identification information of a electronic paper associated with identification information of content written onto and displayed on the electronic paper;
transmitting, in accordance with reception of a request from a writing device, content to the writing device, the request which includes identification information of electronic paper to be written; and
storing the identification information of the content to be transmitted to the writing device, in accordance with the reception of the request from the writing device, associated with the identification information of the electronic paper.

11. The computer readable medium according to claim 10,
wherein the writing device writes a content image onto electronic paper which displays and retains an image in a no-power state and is configured to rewrite the image, and
the writing device includes:
a writing section that writes an image onto electronic paper;
an image retaining section that stores an image for erasure;
a judging section that reads an image displayed on and retained in electronic paper for writing and judges conformity of the image read by the judging section with the image for erasure; and
a control section that transmits, in accordance with a judgment result indicating the conformity with the image for erasure, the request including the electronic paper identification information.

12. A computer readable medium storing a program causing a computer to execute a process for managing contents, the process comprising;
writing an image onto electronic paper which displays and retains an image in a no-power state and is configured to rewrite the image;
storing an image for erasure;
reading an image displayed on and retained in electronic paper for writing and judging conformity of the read image with the image for erasure; and
transmitting, in accordance with a judgment result indicating the conformity with the image for erasure, the request including the electronic paper identification information to a management device.

13. The computer readable medium according to claim 12,
wherein the management device that manages content to be written onto and displayed on electronic paper, and
the management device includes:
a management section that manages identification information of the electronic paper associated with identification information of content written onto and displayed on the electronic paper;
a control section that, in accordance with reception of a request, transmits content, the request which includes identification information of electronic paper to be written; and
an update section that stores, in the management section, the identification information of the content to be transmitted, in accordance with the reception of the request, associated with the identification information of the electronic paper.
